(19) United States
(12) Patent Application Publication
(10) Pub. No.: US 2007/0060712 A1
(43) Pub. Date: Mar. 15, 2007

(54) Thermoplastic composition with improved wear properties and method for making thereof

(75) Inventor: Nicola Cont, Bergen op Zoom (NL)

Correspondence Address: GEAM - LNP-CE 08CE;IP LEGAL, ONE PLASTICS AVENUE, PITTSFIELD, MA, 01201-3697, US

(73) Assignee: General Electric Company

(21) Appl. No.: 11/289,258

(22) Filed: Nov. 29, 2005

Related U.S. Application Data
(60) Provisional application No. 60/718,496, filed on Sep. 15, 2005.

(51) Int. Cl. C08L 67/02; C08L 77/06

(52) U.S. Cl. 525/425; 525/426

(57) ABSTRACT

Self-lubricating compositions with improved friction, wear and/or melt flow properties are provided as well as a method of improving the friction, wear and/or melt flow properties of a polyester base resin. The composition includes a mixture of a polyester base resin with an aramid powder in amounts effective to provide the improved properties, and optionally, a low-density polyethylene.

### CROSS REFERENCE TO RELATED APPLICATION

This application claims priority to U.S. Provisional Patent Application No. 60/718496, which was filed Sep. 19, 2005.

### FIELD OF INVENTION

The present invention relates to thermoplastic compositions with improved shrinkage and wear properties.

### BACKGROUND OF INVENTION

It has become useful to provide thermoplastic compositions that are used in a wide variety of environments wherein characteristics such as good wear, friction and/or melt flow properties have been improved. In one aspect, good wear, friction and/or melt flow properties in thermoplastic compositions have been attempted by using fluorinated hydrocarbons, such as polytetrafluoroethylene (PTFE), as lubricant additives. However, in many areas of the world, particularly in Europe, fluorinated materials are creating increasing concern due to the potential of these substances to act as environmental hazards. As a result, it is becoming increasingly important to develop alternative, non-fluorinated lubricants for thermoplastic compositions that are capable of delivering equivalent or improved mechanical properties.

U.S. Pat. Nos. 4,737,539 and 5,216,079 teach that polyolefins of a molecular weight less than 500,000, alone or in a blend with PTFE, may act as internal lubricants for various polymer matrixes including polyamides, polyesters, polyoxymethylene, polyphenylene sulfide, aromatic carbonate polymers, styrene homopolymers and copolymers, polyolefins. In addition, U.S. Pat. Nos. 4,737,539 and 4,877,813 teach use of PTFE and polyamide fibers to stabilize the coefficient of friction in certain resin compositions, including polyolefins, polycarbonate and polyamide.

U.S. Pat. No. 5,474,842 discloses the use of aramid particles having a size of 75 to 250 microns in thermoset or thermoplastic compositions for improved wear resistant. U.S. Pat. No. 5,523,352 discloses the use of a low-density polyethylene and an aramid powder in polyoxyalkylene to improve its friction, wear and melt flow properties.

There is a need for eco-friendly compositions that may include reduced shrinkage and/or improved wear properties. Applicants have found that the use of aramid powder in polyester compositions provides compositions with excellent mechanical properties compared to prior art compositions containing fluorinated hydrocarbons.

### BRIEF DESCRIPTION OF THE INVENTION

In one aspect, the present invention includes a self-lubricating composition that includes a mixture of a polyester resin, an aramid powder, and in select embodiments, a low-density polyethylene. The aramid powder and optional low-density polyethylene may be mixed in amounts effective to provide improved friction, wear and/or melt flow properties to the polyester composition.

In another aspect, the present invention includes a method for improving the wear, friction and/or melt flow properties of a polyester base resin. The method includes melt mixing a polyester base resin, an aramid powder and, in select embodiments, a low-density polyethylene in amounts capable of providing improved lubrication, wear and/or melt flow properties to the polyester composition.

### DETAILED DESCRIPTION

The terms “a” and “an” herein do not denote a limitation of quantity, but rather denote the presence of at least one of the referenced item. All ranges disclosed herein are inclusive and combinable. Furthermore, all ranges disclosed herein are inclusive of the endpoints and are independently combinable. Also, as used in the specification and in the claims, the term “comprising” may include the embodiments “consisting of” and “consisting essentially of.”

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases. In at least some instances, the approximating language may correspond to the precision of an instrument for measuring the value.

As used herein, the phrase “effective amount” or “sufficient amount” means that amount sufficient to bring about the desired lubricity effect to the polymeric composition, i.e., the polymeric composition having a wear factor lower than the wear factor of a polymeric composition not having this effective amount and/or having an equivalent amount of PTFE. In one embodiment, the desired lubricity effect means the composition having a wear factor of at least 10% less than the wear factor of a polymeric composition not having the effective amount. In a third embodiment, the desired lubricity effect means the composition having a wear factor of at least 25% less than the wear factor of a polymeric composition not having the effective amount.

The composition of the invention generally includes, in one embodiment, a polyester component A and an aramid powder as component B. In optional embodiments, a polyethylene as component C may also be included. The composition is useful in applications utilizing lubricated materials, including those that may be resistant to wear and/or having reduced shrinkage properties.

Component A—Polyester Component. In one aspect, the present invention includes the use of a first component, Component A, which may be a polyester component. Polyesters as used herein include crystalline polyesters such as polyesters derived from an aliphatic or cycloaliphatic diols, or mixtures thereof, containing from 2 to about 10 carbon atoms and at least one aromatic dicarboxylic acid. Specific polyesters are derived from an aliphatic diol and an aromatic dicarboxylic acid having repeating units of the following general formula: 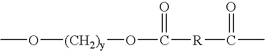
wherein y is an integer of from 2 to 6. R is a C₆-C₂₀ aryl radical including a decarboxylated residue derived from an aromatic dicarboxylic acid.

Examples of aromatic dicarboxcylic acids represented by the decarboxylated residue R are isophthalic or terephthalic acid, 1,2-di(p-carboxyphenyl)ethane, 4,4′-dicarboxydiphenyl ether, 4,4′-bisbenzoic acid and mixtures thereof. All of these acids contain at least one aromatic nucleus. Acids containing fused rings may also be present, such as in 1,4-, 1,5-, or 2,6-naphthalenedicarboxylic acids. Exemplary dicarboxcylic acids include, but are not limited to, terephthalic acid, isophthalic acid, naphthalene dicarboxcylic acid or mixtures thereof.

Exemplary polyesters that may be used in select embodiments of the present invention include, but are not limited to, poly(ethylene terephthalate) (“PET”), and poly(1,4-butylene terephthalate), (“PBT”), poly(ethylene naphthanoate) (“PEN”), poly(butylene naphthanoate), (“PBN”) and poly(propylene terephthalate) (“PPT”).

In other alternative embodiments, it is contemplated the use of the above polyesters with minor amounts, e.g., from about 0.5 to about 5 percent by weight, of units derived from aliphatic acid and/or aliphatic polyols to form copolyesters. The aliphatic polyols may include glycols, such as poly(ethylene glycol). Such polyesters may be made following the teachings of, for example, U.S. Pat. Nos. 2,465,319 and 3,047,539.

An exemplary poly(1,4-butylene terephthalate) resin that may be used in one embodiment of the present invention is one obtained by polymerizing a glycol component of at least 70 mol %, specifically at least 80 mol %, of which includes tetramethylene glycol and an acid component at least 70 mol %, specifically at least 80 mol %, of which includes terephthalic acid, or polyester-forming derivatives therefore.

The polyesters that may be used herein have, in select embodiments, an intrinsic viscosity of from about 0.4 to about 2.0 dl/gas measured in a 60:40 phenol/tetrachloroethane mixture or similar solvent at 23°-30° C. In one embodiment, the polyester may be VALOX 315 polyester, available from General Electric. VALOX 315 polyester is suitable in the present invention since it has an intrinsic viscosity of about 1.1 to about 1.4 dl/g.

Blends of polyesters may also be employed in the composition as component A. In one embodiment, the blended polyester may include the combination of poly(ethylene terephthalate) and poly(1,4-butylene terephthalate). When blends of these components are employed, the polyester resin component may include from about 1 to about 99 parts by weight poly(ethylene terephthalate) and from about 99 to about 1 part by weight poly(1,4-butylene terephthalate) based on 100 parts by weight of both components combined.

The amount of polyester component in the composition may be, in one embodiment, about 60 to about 99 wt. % of the total weight of the composition. In another embodiment, the amount of polyester component in the composition may be from about 70 to about 97 wt. %. In another embodiment, amount of polyester component in the composition may be in an amount of less than about 95 wt. %. In yet another embodiment, amount of polyester component in the composition may be in an amount of more than about 75 wt. %.

Component B—Aramid Powder The term “aramid polymer” as used in the present invention refers to, in one embodiment, wholly aromatic polycarbonamide polymers and copolymers including recurring units of the formula—HN—AR₁—NH—CO—AR₂—CO—(I), wherein AR₁ and AR₂, which may be the same or different, represent divalent aromatic groups. A comprehensive disclosure of the composition of aramid polymers may be found in U.S. Pat. No. 3,673,143 as well as the divisional patent thereof, U.S. Pat. No. 3,817,941, the teachings of which are herein incorporated by reference.

In one embodiment, the aramid polymer is a para-aramid. As used herein, a “para-aramid” refers to para-oriented aromatic polycarbonamides of Formula I, above, wherein AR₁ and AR₂, which may be the same or different and/or may represent divalent, para-oriented, and/or aromatic groups. By “para-oriented” is meant that the chain extending bonds from aromatic groups are either coaxial or parallel and oppositely directed, for example, substituted or unsubstituted aromatic groups including 1,4-phenylene, 4,4′-biphenylene, 2,6-naphthalene, and 1,5-naphthalene. In one embodiment, substituents on the aromatic groups other than those which are part of the chain extending moieties are nonreactive and not adversely affecting the characteristics of the polymer. Examples of suitable substituents include, but are not limited to, chloro, lower alkyl and methoxy groups.

The term para-aramid also encompasses para-aramid copolymers of two or more para-oriented comonomers, including minor amounts of comonomers, where the acid and amine functions coexist on the same aromatic species, e.g., copolymers produced from reactants such as 4-aminobenzoyl chloride hydrochloride, 6-amino-2-naphthoyl chloride hydrochloride, and the like. In one embodiment, the aramid polymer is a copolymer containing minor amounts of comonomers containing aromatic groups that are not para-oriented, such as, for example, m-phenylene and 3,4′-biphenylene. In another embodiment, the aramid powder is in the form of an aromatic aramid such as poly(para-phenylene-terephthalatemide).

In one embodiment, the aramid powder includes para-aramids in the form of poly(p-phenyleneterephthalamide). In another embodiment, aramid powder or particles may be made by comminuting aramid polymer to the desired size as disclosed in U.S. Pat. Nos. 3,063,966 and 4,308,374. The aramid powder may be finished in the form of a water-wet crumb, which may be dried and then pulverized in a hammer mill to an average diameter of 5 to 500 microns. Once dried and pulverized, the aramid particles may be classified and particles of the desired size range may be isolated for use. In one embodiment, the aramid powder has an average particle size of 5 to 100 microns as measured in the longest particle dimension. In another embodiment, the aramid powder has an average particle size of from 50 to 100 microns. In a third embodiment, the aramid powder has an average particle size of less than 20 microns.

Aramid powder particles are commercially available from a number of sources, including Teijin and Akzo Nobel. An example is Twaron 5011 aramid powder with an average particle size of 55 microns, which is available from Akzo Nobel.

The aramid powder is present in a sufficient amount to provide the desired lubricating effect. The amount of aramid powder component in the composition may be, in one embodiment, about 1 to about 30 wt. % of the total weight of the composition. In another embodiment, the amount of aramid powder component in the composition may be from about 3 to about 20 wt. %. In still another embodiment, the amount of aramid powder component in the composition may be in an amount of less than 10 wt. %. In yet another embodiment, the amount of aramid powder component in the composition may be in an amount of more than 4 wt. %.

In one embodiment, the polyester and the aramid powder are present in a range of weight percentage ratios of 1:03 to 1:30.

Optional Lubricating Component C In one embodiment, a minor amount of a polyethylene, e.g., a low-density polyethylene (LDPE) may be added.

In another embodiment, the LDPE is a commercially available LDPE homopolymer or copolymer that has an MW of from about 25,000 to about 300,000. In one embodiment, the LDPE has an Mw of less than or equal to about 220,000 and greater than or equal to about 50,000. The LDPE may be either branched or linear. In one example, it is a linear LDPE homopolymer that remains as discrete identifiable particles after melt mixing or processing the composition. Examples of LDPEs include, but are not limited to, Escorene™ from Exxon and Lupolen™ from BASF.

In one embodiment, the LDPE is added to the composition in an amount of about 0.5 wt. % to 20 wt. % of the final composition. In a second embodiment, the LDPE is added to the composition in an amount from 1 to 15 wt. %. In a third embodiment, the LDPE is added to the composition in an amount of less than 10 wt. %.

Optional Filler Component: The composition may further include a filler component, including fibrous filler and/or low aspect ratio filler. Suitable fibrous fillers include, but are not limited to, any conventional filler that may be used in polymeric resins and having an aspect ratio greater than 1, e.g., whiskers, needles, rods, tubes, strands, elongated platelets, lamellar platelets, ellipsoids, micro fibers, nanofibers and nanotubes, elongated fullerenes, and the like. Where such fillers exist in aggregate form, an aggregate having an aspect ratio greater than 1 may also be used for the fibrous filler.

Other examples of fillers include, but are not limited to, glass fibers, such as E, A, C, ECR, R, S, D, and NE glasses and quartz, and the like. Other suitable inorganic fibrous fillers include those derived from blends including at least one of aluminum silicates, aluminum oxides, magnesium oxides, and calcium sulfate hemihydrate. Also included among fibrous fillers are single crystal fibers or “whiskers” including silicon carbide, alumina, boron carbide, iron, nickel, or copper. Other suitable inorganic fibrous fillers may include carbon fibers, stainless steel fibers, metal coated fibers, and the like.

In addition, in certain embodiments, organic reinforcing fibrous fillers may also be used including organic polymers capable of forming fibers. Illustrative examples of such organic fibrous fillers include, but are not limited to, poly(ether ketone), polyimide, polybenzoxazole, poly(phenylene sulfide), polycarbonate, aromatic polyamides including aramid, aromatic polyimides or polyetherimides, polytetrafluoroethylene, acrylic resins, poly(vinyl alcohol), or combinations thereof. Such reinforcing fillers may be provided in the form of monofilament or multifilament fibers and may be used either alone or in combination with other types of fibers, through, for example, co-weaving or core/sheath, side-by-side, orange-type or matrix and fibril constructions, or by other methods known to one skilled in the art of fiber manufacture.

Non-limiting examples of low aspect fillers include, but are not limited to, silica powder; boron-nitride powder and boron-silicate powders; alkaline earth metal salts; alumina and magnesium oxide (or magnesia); wollastonite, including surface-treated wollastonite; calcium sulfate; calcium carbonates including chalk, limestone, marble and synthetic, precipitated calcium carbonates; surface-treated calcium carbonates; other metal carbonates; talc; glass powders; glass-ceramic powders; clay; mica; feldspar and nepheline syenite; salts or esters of orthosilicic acid and condensation products thereof; zeolites; quartz; quartzite; perlite; diatomaceous earth; silicon carbide; zinc sulfide; zinc oxide; zinc stannate; zinc hydroxystannate; zinc phosphate; zinc borate; aluminum phosphate; barium titanate; barium ferrite; barium sulfate and heavy spar; particulate aluminum, bronze, zinc, copper and nickel; carbon black; flaked fillers; combinations thereof, and the like. Examples of such fillers well known to the art include those described in “Plastic Additives Handbook, 4^{th} Edition” R. Gachter and H. Muller (eds.), P. P. Klemchuck (assoc. ed.) Hansen Publishers, New York 1993.

The total amount of filler present in the composition may be, in one embodiment, about 0.1 to about 50 wt. % of the total weight of the composition. In another embodiment, the total amount of filler present in the composition may be in an amount of 3 to about 30 wt. %. In yet another embodiment, total amount of filler present in the composition may be from about 5 to about 20 wt. %.

Optional Additive Component: In alternative embodiments, other additives may be added to all of the resin compositions at the time of mixing or molding of the resin in amounts as necessary which do not have any deleterious effect on physical properties. For example, one or more of coloring agents (pigments or dyes), heat-resistant agents, oxidation inhibitors, organic fibrous fillers, weather-proofing agents, antioxidants, lubricants, mold release agents, flow promoters, plasticizer, fluidity enhancing agents, and the like, commonly used in thermoplastic compositions may also be added in beneficial amounts.

It should be clear that the invention encompasses reaction products of the above-described compositions. The composition including the aramid powder of the invention may include thermoplastic materials other than polyester for the component A, such as polyamide, polycarbonate, polyolefin, ABS, and combinations therefore. In one embodiment, the component A is a polyamide, for a composition including a polyamide and the aramid powder. In another embodiment, the composition includes a blend of polyamide and polyester for component A, and an effective amount of an aramid powder in the form of particles having an average particle size as measured in the longest dimension of from about 5 to about 100 microns. In yet another embodiment, the composition further includes an effective amount of a low-density polyethylene to further improve the wear properties.

Method for Manufacturing the Composition: The composition may be melt blended or solution blending. Melt blending of the composition involves the use of shear force, extensional force, compressive force, ultrasonic energy, electromagnetic energy, thermal energy or combinations including at least one of the foregoing forces or forms of energy and is conducted in processing equipment wherein the aforementioned forces are exerted by a single screw, multiple screws, intermeshing co-rotating or counter rotating screws, non-intermeshing co-rotating or counter rotating screws, reciprocating screws, screws with pins, barrels with pins, rolls, rams, helical rotors, or combinations including at least one of the foregoing.

Melt blending involving the aforementioned forces may be conducted in machines such as single or multiple screw extruders, a Buss kneader, Eirich mixers, a Henschel, helicones, a Ross mixer, a Banbury, roll mills, molding machines such as injection molding machines, vacuum forming machines, blow molding machines, or the like, or combinations including at least one of the foregoing machines.

The composition may be manufactured by a number of methods. In one embodiment, the thermoplastic polymer, the aramid powder, and any additional optional ingredients are compounded in an extruder and extruded to produce pellets. In another embodiment, the composition is mixed in a dry blending process (e.g., in a Henschel mixer) and directly molded, e.g., by injection molding or any other suitable transfer molding technique.

The composition may be extruded into granules or pellets, cut into sheets or shaped into briquettes for further downstream processing. The composition may then be molded in equipment generally employed for processing thermoplastic compositions, e.g., an injection-molding machine.

Method for Manufacturing the Composition—Masterbatching. In another exemplary method of manufacturing the thermoplastic composition, the aramid powder may be master batched into the polyester blend. The master batch may then be let down with additional polymer during the extrusion process or during a molding process to form the composition.

Articles from the Composition The compositions may be made into articles using known techniques such as film and sheet extrusion, injection molding, gas-assisted injection molding, extrusion molding, compression molding and blow molding. The composition may be used to prepare molded articles such as durable articles, structural products, and electrical and electronic components, and the like, particularly in tribological applications in which a surface formed of the present composition bears against another surface, including another different plastic surface or a metal surface. In one embodiment, the composition may be used as an alternative material to polyacetal for gear applications without requiring the use of PTFE or fluorinated material, and with impact properties comparable to that of polyacetal.

Properties of the Composition The compositions of the present invention exhibit excellent wear, friction and/or melt flow properties that are comparable, and in many cases better, than the same properties achieved by compositions including fluoropolymeric lubricants such as PTFE. In one embodiment, the composition shows a wear factor comparable to polyester compositions containing PTFE, i.e., with a wear factor of less than 100 and/or a coefficient of dynamic friction (COF) of less than 0.50 as measured in a tribological system in which a metal surface bears against a plastic surface. Additionally, the composition may have a specific gravity of less than 1.350 with the aramid powder and optional polyolefin providing an isotropic shrinkage.

All cited patents, patent applications, and other references are incorporated herein by reference in their entirety. The invention is further illustrated by the following non-limiting examples.

### EXAMPLES

The formulations for the examples, the tests conducted and results thereof are presented in Table 1 below.

The PBT polymer used in all examples is available from General Electric Company as VALOX PBT 315 resin. In some examples, a branched polyethylene under the tradename of LUPOLEN from BASF is used. In the comparable examples, a PTFE powder from Asahi as FL1650 is used as the lubricant. The aramid powder is commercially available from Akzo Nobel as Twaron 5011. In all examples, the compositions are prepared by extrusion compounding using W&P extruder having a 25 mm screw diameter. Samples prepared from the compositions were evaluated for their mechanical, ear, friction, and melt flow properties using test methods as indicated in the table.

TABLE 1

| Test description | Test Method | Unit | #1 | #2 | #3 | #4 | #5 | #6 | #7 |
|---|---|---|---|---|---|---|---|---|---|
| Moisture Content | S.O.P. 114/LNP | % | 0.15 | 0.15 | 0.15 | 0.14 | 0.15 | 0.14 | 0.15 |
| Specific Gravity | ISO 1183 | g/ccm | 1.365 | 1.409 | 1.377 | 1.288 | 1.291 | 1.304 | 1.329 |
| Izod Impact Strength Notched | ISO 180/1A | kJ/m2 | 4.9 | 5.0 | 4.1 | 5.9 | 4.7 | 3.7 | 3.3 |
| Izod Impact Strength Unnotched | ISO 180/1U | kJ/m2 | 53.7 | 38.7 | 23.4 | 150.2 | 28.2 | 17.6 | 20.8 |
| Tensile Strength | ISO 527-1 | MPa | 51 | 47 | 43 | 52 | 43 | 42 | 46 |
| Tensile Elongation | ISO 527-1 | % | 22.5 | 18.3 | 9.5 | 58.8 | 11.7 | 3.6 | 6.5 |
| Tensile-E-Modulus | ISO 527-1 | GPa | 2.4 | 2.3 | 2.6 | 2.3 | 2.4 | 2.7 | 2.9 |
| Flexural Strength | ISO 178 | MPa | 78 | 73 | 77 | 72 | 74 | 77 | 86 |
| Flexural Modulus | ISO 178 | GPa | 2.5 | 2.4 | 2.7 | 2.3 | 2.5 | 2.8 | 3.0 |
| Shrinkage | | % | 2.22 | 2.29 | 2.09 | 2.13 | 2.24 | 2.04 | 1.97 |
| MVR 250° C./2.16 kg | ISO 1133 | cm³/10 min | 13.3 | 12.0 | 12.8 | 12.6 | 12.0 | 9.0 | 15.0 |
| Wear factor K - Left machine | D3702-LNP | | 50.21366 | 33.72549 | 101.3 | 70.8 | 64.1176 | 39.4535 | 37.900 |
| Wear factor K - Right machine | D3702-LNP | | 74.30671 | 32.24844 | 85.7 | 35.6 | 27.6017 | 9.65042 | 27.200 |
| Average | | | 62.26018 | 33.48696 | 93.5 | 53.2 | 45.85964 | 24.55196 | 32.55 |
| COF Dynamic | | | 0.397 | 0.15 | 0.196 | 0.159 | 0.219 | 0.219 | 0.395 |
| COF Dynamic | | | 0.23 | 0.18 | 0.188 | 0.115 | 0.25 | 0.234 | 0.301 |
| *PBT 315 | | | 90.000 | 80.000 | 80.000 | 95.000 | 85.000 | 75.000 | 85.000 |
| Lupolen 1800 H | | | | | | 5.000 | 5.000 | 5.000 | |
| FL1650 | | | 10.000 | 20.000 | 10.000 | | | | |
| Twaron powder Feeder 2 (FW 40+) | | | | | 10.000 | | 10.000 | 20.000 | 15.000 |

The wear factor properties were measured by forming a sample part from each composition and causing a surface of the sample part to bear against a stainless steel surface, i.e. the friction and wear properties are measured for a plastic/metal tribological system. The results show that addition of aramid powder to the polyester provided an improved isotropic shrinkage, comparable flexural strength flexural modulus and/or melt flow properties, and excellent wear factor (K) in comparison to the self-lubricating polyester compositions with the fluoropolymeric lubricant PTHE of the prior art.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

All citations referred herein are expressly incorporated herein by reference.

1. A self-lubricating composition, comprising a mixture of:
a. a polyester base resin; and
b. an aramid powder in the form of particles having an average particle size as measured in the longest dimension of from about 5 to about 100 microns.

2. The composition of claim 1, further comprising a low-density polyethylene.

3. The composition according to claim 2, wherein the low-density polyethylene has a weight average molecular weight of from about 25,000 to about 300,000.

4. The composition of claim 1, wherein the aramid powder is present in an amount of 1 to 30 wt. %.

5. The composition of claim 4, wherein the aramid powder is present in an amount of 3 to 25 wt. %.

6. The composition of claim 5, wherein the aramid powder is present in an amount of 5 to 20 wt. %.

7. The composition of claim 1, wherein the composition is free of fluoropolymeric lubricant additives.

8. The composition of claim 1, further comprising at least one additive selected from fillers, reinforcing agents, plasticizers, heat stabilizers, ultraviolet stabilizers, tougheners, antistatic agents, colorants or a combination thereof.

9. The composition of claim 1, wherein the aramid powder comprises a poly(para-phenylene-terephthalamide) having a weight average molecular weight from about 20,000 to about 45,000.

10. The composition according to claim 1, wherein the aramid powder is in the form of particles having an average particle size as measured in the longest dimension of from about 30 to about 90 microns.

11. The composition according to claim 1, wherein the polyester base resin is selected from the group of poly(ethylene terephthalate), poly(1,4-butylene terephthalate), and mixtures and blends thereof.

12. A method for improving properties of a polyester base resin, comprising the steps of:
melt mixing the polyester base resin with a lubricating amount of an aramid powder.

13. The method according to claim 12, further comprising melt mixing a low-density polyethylene with the polyester base resin and the aramid powder.

14. The method according to claim 13, further comprising the step of melt mixing the low density polyethylene and the aramid powder in a range of weight percentage ratios of from about 1:0.03 to about 1:20 of the low density polyethylene to the aramid powder.

15. The method according to claim 13, wherein the aramid powder is melt mixed in an amount of about 0.5 wt % to about 20 wt % of a final mixture and the low density polyethylene is melt mixed in an amount of about 0.5 wt % to about 20 wt % of the mixture.

16. The method according to claim 12, wherein the polyester base resin is selected from the group of poly(ethylene terephthalate), poly(1,4-butylene terephthalate), and mixtures and blends thereof.

17. The method according to claim 12, further comprising the step of melt mixing at least one additive selected from fillers, reinforcing agents, plasticizers, heat stabilizers, ultraviolet stabilizers, tougheners, antistatic agents, colorants, or combinations thereof into the mixture.

18. The method according to claim 12, wherein the aramid powder is melt mixed with the polyester base resin in the form of particles having an average particle size as measured in the longest dimension of from about 10 to about 100 microns.

19. An article comprising the composition of claim 1.

20. An article comprising the composition of claim 2.

21. A self-lubricating composition, consisting essentially of:
a. a thermoplastic base resin; and
b. an aramid powder in the form of particles having an average particle size as measured in the longest dimension of from about 5 to about 100 microns.

22. The composition of claim 21, further comprising a low-density polyethylene.
